(19) United States
(12) Patent Application Publication
(10) Pub. No.: US 2016/0111920 A1
(43) Pub. Date: Apr. 21, 2016

(54) ENERGY MANAGEMENT DEVICE AND ITS ASSOCIATED METHOD

(71) Applicant: ELECTRICITE DE FRANCE, Paris (FR)

(72) Inventors: Daniel Pignier, Bourg La Reine (FR); David Menga, Verrieres Le Buisson (FR)

(21) Appl. No.: 14/778,455

(22) PCT Filed: Mar. 19, 2013
(86) PCT No.: PCT/IB13/00711

§ 371 Date: Sep. 18, 2015

(51) Int. Cl. H02J 9/06; H02J 7/00

(52) U.S. Cl. CPC H02J 9/062; H02J 7/0068

(57) ABSTRACT

An energy management device and its associated method for optimizing the energy distribution in residences are provided. The device is suitable to be electrically connected to a set of apparatuses such as a power grid, alternative energy sources, distribution boards and energy storage units. The device comprises at least: processing and control means for optimizing, in accordance with at least one first local data, the electric energy distribution, and an uplink telecommunication facility suitable for sending, to a remote server of a provider of energy distributed over the power grid, at least one second local data relative to the optimized energy distribution. The provider may thus know local data relative to the optimized energy distribution and, if appropriate, adjust the energy supplied by the power grid.

The invention generally relates to the field of energy management, and more particularly, to an energy management device and its associated method for optimizing the energy distribution in residences and businesses.

Energetic efficiency is a real issue. This issue could not be addressed without taking into account for energy consumed by buildings, since this latter represents 40% of the total consumed energy, among which 70% for residency.

Authorities are conscious of this reality and issue thermic regulations which not only are imposed on energy providers, but also are great opportunities for said providers on the one hand of improving devices relative to this issue, on the other hand of developing associated services.

For example, two thermic regulations are currently imposed for new residences, which aim at a reduction of the average consumption to 50 kWh/m² per year in 2012 and at a reduction of the average consumption to 0 kWh/m² per year in 2020, respectively.

Achieving these aims implies to reduce the consumption at least in each of the following technical domains: heating, air-conditioning, domestic hot water (DHW), ventilation, lighting and alternative energy sources, such as photovoltaic cells, micro-hydroelectric power generators, gas turbines, windmills or fuel cells.

Furthermore, it should be noted that energy consumption per residence depends on technical features of said residence as well as residents themselves and their usages.

It should not be forgotten the generalized aging of housing stock. Even if it does not make the object of a thermic regulation at this time, requirements for the establishment of electricity audit for residences of more than 15 years and for joining, at each real estate transaction, an energetic certification lead to the conclusion that renovation is a major issue by both of built isolation and of energetic and electric renovation.

To achieve the aims fixed by above mentioned regulations requires, beyond essential regulations about built, to measure, to count, to monitor and to act on energy consumption inside the residence.

It is thus needed to follow each consumer in its daily energy management.

In this context, the invention provides an energy management device and its associated method allowing to address the above mentioned issues.

To this end, the energy management device is essentially such that it is suitable to be connected by electrical distribution paths to a set of apparatuses comprising at least:
a power grid,
at least one alternative energy source,
at least one distribution board suitable for transmitting electric energy to at least one consumption device, and
at least one energy storage unit suitable for storing electric energy supplied at least by said alternative energy source and for supplying at least a part of stored electric energy to said power grid and/or to said distribution board,

the energy management device comprising :
processing and control means for optimizing, in accordance with at least one first local data, the electric energy distribution:
   to the power grid from the alternative energy source or from the energy storage unit,
   to the distribution board from the power grid, from the alternative energy source or from the energy storage unit, and
   to the energy storage unit from the power grid or from the alternative energy source,
an uplink telecommunication facility suitable at least for sending, to a remote server held by a provider of energy distributed over the power grid, at least one second local data relative to the optimized energy distribution.

The words “local data” are meant to aim data relative to the residence or the business into which the energy management device is installed. Local data may thus be data related to each apparatus and/or each consumption device, or related to location of said residence or business, including for example geolocation and weather.

Advantageously, the provider may thus know some local data relative to the optimized energy distribution and, if appropriate, adjust at least the electric energy supplied to said energy management device by the power grid. Notably, a method of real time management and modulation of electricity consumption, such as described in WO 03084022, U.S. Pat. No. 6,868,293 B1, U.S. Pat. No. 7,313,465 B1 and U.S. Pat. No. 8,364,322 B2 for instances, may be performed. It can consist, for instance, for the provider in granting a lower price to the consumer for electric energy supplied from the power grid in exchange of a commitment according to which the energy consumption of his/her residence should remain lower than a determined threshold value. Said method may be implemented in accordance with a contract previously agreed between the provider of electric energy over the power grid and the consumer. The energy management device allows to accordingly and automatically control the consumption of electric energy which is supplied by said alternative energy source or stored by the energy storage unit, in order to fulfill the contract.

According to another feature, the energy management device further comprises a downlink telecommunication facility suitable for receiving, from said remote server, at least one data remotely generated at least by said remote server in function of said second local data.

Advantageously, the provider can thus act on, or suggest improvement of, the optimized energy distribution.

According to another feature, said energy management device being suitable to be connected to a set of captors, a part of which is arranged together with the apparatuses and/or with said at least one consumption device, said at least one first and/or second local data comprises at least one basic or pretreated data relative to:
determined operating conditions of said at least one consumption device and/or said energy management device,
a determined order of priorities for electric energy supplied at least between consumption devices,
a measure of current and/or voltage at the terminals of at least one of said apparatuses and/or of said at least one consumption device,
a measure of an amount of electric energy produced by said at least one alternative energy source,
a measure of the current consumed by said at least one consumption device,
a measure of the charge level of said at least one energy storage unit,
a measure of air and environment quality, and/or
a measure of meteorological conditions,

with said at least one pretreated data being generated by processing means of the energy management device in function of the hereabove mentioned measures.

According to another feature, said at least one remotely generated data comprises at least one of:
a measure or prediction of consuming energy by said at least one consumption device during a past or future determined period of time, respectively, and/or an associated cost,
a measure or prediction of supplied energy by said at least one alternative energy source during a past or future determined period of time, respectively, and/or an associated gain,
a request from the provider for supplying electric energy to the power grid in a determined amount and/or during a determined period of time,
a request from the provider for limiting the energy consumption from the power grid under a determined threshold and/or during a determined period of time,
an alert or warning signal or message in case of detection of:
   an electric fault,
   a polluted air or environment, or
   an exceeding with respect to a determined threshold of energy consumption from the power grid,
an update of optimization algorithm implemented by processing means of the energy management device,
a message corresponding to a piece of advice for enhancing:
   the optimization of energy distribution in function of at least one detected aberration, and/or
   the efficiency of the alternative energy source, and
a diagnosis of the energy management device.

According to another feature, said downlink telecommunication facility is further suitable for receiving from said remote server at least one of the following data relative to power grid state:
a data relative to the current or predicted state or cost of energy distributed over the power grid, and
an alert or warning signal or message in case of a planned outage or brownout of the power grid and, if appropriate, its estimated or planned duration.

Both of these two downlink data do not depend on local data, but only on power grid state. Thus, generating these two downlink data does not require to know local data and these two downlink data may be generated by the remote server and received from the energy management device, through its downlink telecommunication facility, without requiring previously sending local data from the energy management device to the remote server.

Advantageously, the energy management device may thus adjust the optimized energy distribution, in function of these two downlink data.

According to another feature, processing means of the energy management device automatically process remotely generated data or data relative to power grid state and control means of the energy management device consequently adjust the optimized energy distribution.

The energy management device is thus advantageously able to take into account for the data that it received from the remote server in order to take measures for enhancing the optimized energy distribution, if appropriate.

According to another feature, the energy management device comprises memorization support means for storing at least a list of second local data type that the energy management device is authorized to send to the remote server of the provider.

Advantageously, the consumer may forbid transmission to the remote server of some determined data, for example in order to protect its privacy.

According to another feature, the energy management device hosts a website to which an authenticated personal communication device is able to connect:
for displaying at least messages received from the remote server and/or
for enabling the user of said personal communication device to control the energy management device.

Advantageously, the consumer may perform setting of the energy management device by help of his/her personal communication device, such as his/her smartphone or tablet computer. Furthermore, the consumer may perform setting of the energy management device by taking into account for some pieces of advice given by the provider.

According to another subject, the invention relates to an energy management method implemented by an energy management device suitable to be connected by electrical distribution paths to a set of apparatuses comprising at least:
a power grid,
at least one alternative energy source,
at least one distribution board suitable for transmitting electric energy to at least one consumption device, and
at least one energy storage unit suitable for storing electric energy supplied at least by said alternative energy source and for supplying at least a part of stored electric energy to said power grid and/or to said distribution board,

the energy management method comprising :
first processing and controlling steps, implemented by processing and control means of the energy management device, for optimizing, in accordance with at least one first local data, the electric energy distribution:
   to the power grid from the alternative energy source or from the energy storage unit,
   to the distribution board from the power grid, from the alternative energy source or from the energy storage unit, and
   to the energy storage unit from the power grid and/or from the alternative energy source,
an uplink telecommunication step, implemented by an uplink telecommunication facility of the energy management device, for sending, to a remote server held by a provider of energy distributed over the power grid, at least one second local data relative to the optimized energy distribution.

According to another feature, the energy management method further comprises a downlink telecommunication step, implemented by a downlink telecommunication facility of the energy management device, for receiving at least from said remote server at least one data remotely generated at least by said remote server in function of said second local data.

According to another feature, the energy management method further comprises:
a second processing step, implemented by processing means of the energy management device, for automatically processing remotely generated data, and
a second controlling step, implemented by control means of the energy management device, for consequently adjusting the optimized energy distribution.

According to another subject, the invention relates to a computer program stored on a storage medium and executable by a computer or by processing means of an energy management device as described above, this computer program having a sequence of instructions for implementing an energy management method as described above.

Other aims, features and advantages of the invention will become apparent on reading the following description, given merely by way of nonlimiting example, and offered with reference to the appended drawings, in which:

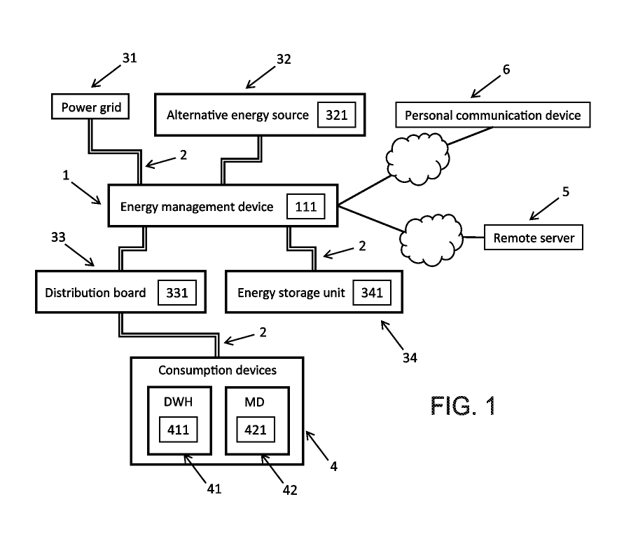

FIG. 1 illustrates the structural context in which an energy management device in accordance with the invention may be used;

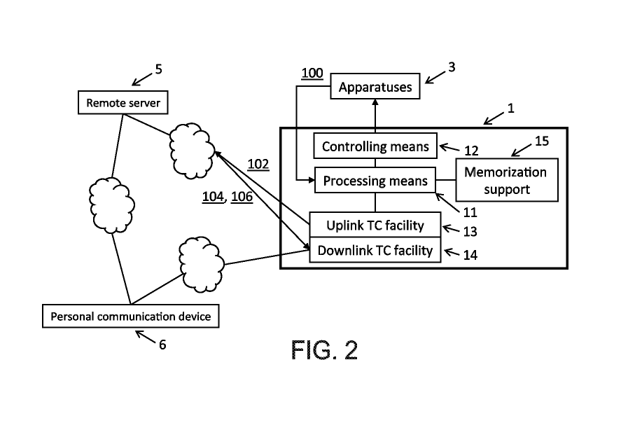

FIG. 2 illustrates the structure of an energy management device in accordance with the invention; and

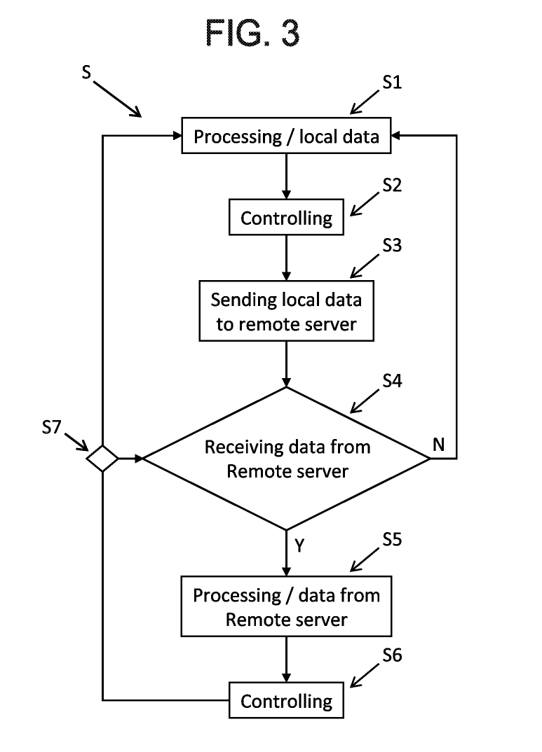

FIG. 3 represents a flowchart of steps of the method in accordance with another subject of the invention.

Represented in FIG. 1 is the structural context in which an energy management device 1 in accordance with the invention may be used. Said energy management device 1 is basically a power inverter, or inverter, that is an electrical power converter that changes direct current to alternating current; the converted alternating current can be at any required voltage and frequency with the use of appropriate transformers, switching, and control circuits of the energy management device 1. Thus, the energy management device 1 described here can be defined as a smart power inverter.

As illustrated on FIG. 1, the energy management device 1 is suitable to be connected by electrical distribution paths 2 to a set of apparatuses 3. This latter comprises at least:
a power grid 31,
at least one alternative energy source 32,
at least one distribution board 33, and
at least one energy storage unit 34.

The power grid 31 is often electrically connected to the energy management device 1 through an energy meter that measures the amount of electric energy consumed by a residence or business.

The distribution board 33 is suitable for dividing an electrical power feed into subsidiary circuits, while providing a protective fuse or circuit breaker for each circuit, in a common enclosure. Normally, a main switch, and in more recent boards, one or more residual-current devices or residual current breakers with overcurrent protection, will also be incorporated. Thus, the distribution board is at least suitable for suitably transmitting/distributing electric energy to at least one consumption device 4, 41, 42.

As illustrated on FIG. 1, among said at least one consumption device 4, 41, 42 are washing machine, dryer, dishwasher, refrigerator, television, computer, Domestic Water Heater (DWH) 41, Medical Device (MD) 42, etc. Some consumption devices may be called smart devices that can receive control signals and send at least their operating conditions data directly to the energy management device 1 or through some relays as said distribution board 33.

The distribution board 33 may comprise memorization support means, a battery, a communication facility and processing means. Optionally, the distribution board 33 may host a website. Thus, the distribution board 33 may be called smart distribution board.

The energy storage unit 34 is suitable for storing electric energy, with this latter being supplied at least by said alternative energy source. The energy storage unit 34 is further suitable for supplying at least a part of stored electric energy to the power grid 31 and/or to the distribution board 33. The electric energy supplied to the power grid 31 is sold to a provider of energy distributed over the power grid 31 or exchanges again services and/or discounts. The electric energy supplied to the distribution board allows to supply energy to the consumption devices 4, 41, 42.

The energy storage unit 34 may be a battery installed in the residence. The energy storage unit 34 may further be a battery of electric vehicle.

The alternative energy source 32 may be photovoltaic cells, mounted on the roof of residence or business; micro-hydroelectric power generators; gas turbines; windmills; fuel cells; etc.

Represented in FIG. 2 is the structure of the energy management device 1 in accordance with the invention.

As illustrated on FIG. 2, the energy management device 1 comprises:
processing means 11,
control means 12,
an uplink telecommunication facility 13,
a downlink telecommunication facility 14, and
memorization support means 15, such as a pSD card.

The energy management device 1 is supplied in electric energy by at least one of the following three sources:
an external input of a DC/DC converter, for example of 12VDC in output,
a Power Over Ethernet (POE) system, for example according to 802.3af specification,
a built-in rechargeable battery, mounted together with a load circuit.

Owing to processing and control means 11, 12, the energy management device 1 is able to optimize the electric energy distribution, with this latter concerning distribution:
to the power grid 31 from the alternative energy source 32 or from the energy storage unit 34,
to the distribution board 33 from the power grid 31, from the alternative energy source 32 or from the energy storage unit 34, and
to the energy storage unit 34 from the power grid 31 and/or from the alternative energy source 32.

The energy storage unit 34 is thus suitable for storing electric energy supplied by the alternative energy source 32 and/or by the power grid 31.

The optimization is at least processed in accordance with at least one first local data 100, that is a data relative to the residence or the business into which the energy management device 1 is installed. First local data 100 may thus be data related:
to each apparatus 31, 32, 33, 34 and/or each consumption device 4, 41, 42, or
to the location of said residence or business, including for example geolocation and current or predicted weather.

In order to optimize the energy distribution in accordance with said at least one first local data 100, the energy management device 1 is suitable to be connected to a set of captors 111, 321, 331, 341, 411, 421. Such a connection is either a direct connection or an indirect connection. Thus, a part of the set of captors 321, 331, 341, 411, 421, which is not directly connected to the energy management device 1 on the contrary of captor 111, is arranged together with the apparatuses 3 and/or with the consumption devices 4, 41, 42.

First local data 100 are then transmitted directly or indirectly to the energy management device 1 by captors 111, 321, 331, 341, 411, 421, for example through a data communication system comprising for example a Power Line Communication (PLC) channel.

The energy management device 1 is provided with three communications channels. First, an Ethernet channel is of 10/100 Base-T specification compatible with 802.3af specification. The Ethernet channel is essentially dedicated to communication with a residential gateway of an Internet service provider or to communication with a switching unit installed in the residence. Second, a Wi-Fi channel is of 802.11 b/g/n specification with a remote antenna, that is an antenna installed into the residence but not necessarily in vicinity of the energy management device 1. The Wi-Fi channel is essentially dedicated to direct communication with consumer interfaces, such as his/her personal communication device 6. Third, the above mentioned PLC channel essentially dedicated to communication with the smart distribution board 33 and, through this latter, with consumption devices 4, 41, 42.

The uplink telecommunication facility 13 of the energy management device 1 comprises thus, for example, the Ethernet channel. Owing to the uplink telecommunication facility 14, the energy management device 1 is suitable at least for sending, to a remote server 5, at least one second local data 102 relative to the optimized energy distribution, with said remote server 5 being held by a provider of energy distributed over the power grid 31.

Said at least one second local data 102 may be the same than the first local data 100. For example, the energy distribution is optimized in order to ensure the operating of the medical device 42 in function of its operating conditions, which are known from the medical device 42 itself or which have been defined by the consumer through consumer interfaces, for example in accordance with a medical prescription. Such data relative to operating conditions of the medical device may also be sent to the remote server 5.

Furthermore, said at least one second local data 102 can be different from the corresponding first local data 100. For example, second local data 102 can be related to an optimization model which is stored in memorization support means 15 of the energy management device 1 and according to which the energy distribution is currently optimized. Thus, second local data 102 are not necessarily coming from a captor.

In a more complete manner, but not necessarily exhaustive, said at least one first and/or second local data 100, 102 comprises at least one data relative to:
determined operating conditions of said at least one consumption device 4, 41, 42 and/or said energy management device 1,
a determined order of priorities for electric energy supplied at least between consumption devices 41, 42,
a measure of current and/or voltage at the terminals of at least one of said apparatuses and/or of said at least one consumption device,
a measure of an amount of electric energy produced by said at least one alternative energy source 32,
a measure of the current consumed by said at least one consumption device 4, 41, 42,
a measure of the charge level of said at least one energy storage unit,
a measure of air and environment quality, and/or
a measure of meteorological conditions.

The hereabove enunciated data kind may be called basic, because they do not depend on the energy management device 1 which only transmits them without any treatment. Nevertheless, the energy management device 1 advantageously comprises processing means 11 suitable to process such basic data by pretreating them, before sending them to the remote server 5. This kind of data may thus be called pretreated data. For example, the energy management device 1 may compute a difference between:
the measure of current and/or voltage at the terminals of a determined consumption device and
the current and/or voltage of set point according to operating conditions of said determined consumption device, then the energy management device 1 may send the result of this computation rather than the measure itself.

Thus some pretreated data may be generated by processing means 11 of the energy management device 1 at least in function of the hereabove mentioned measures.

Owing to such an uplink telecommunication facility 13 of the energy management device 1, the provider may advantageously know some local data relative to the optimized energy distribution and, if appropriate, adjust at least the electric energy supplied to said energy management device 1 by the power grid 31. Moreover, data relative to current meteorological conditions can be extrapolated to neighborhood and, if appropriate, the provider may adjust the electric energy supplied over the power grid 31 with respect to a plurality of residences or businesses.

Notably, a method of real time management and modulation of electricity consumption, as known from prior art, may be performed. This method can consist, for instance, for the provider in granting a lower price to the consumer for electric energy supplied from the power grid in exchange of a commitment according to which the energy consumption of his/her residence should remain lower than a determined threshold value. Said method may be implemented in accordance with a contract previously agreed between the provider of electric energy over the power grid and the consumer. The energy management device allows to accordingly and automatically control the consumption of electric energy which is supplied by said alternative energy source or stored by the energy storage unit, in order to fulfill the contract.

First and/or second local data 100, 102 may be stored locally into the memorization support means 15 of the energy management device 1 for example for a rolling period of 13 months, but may also be sent to a remote secured memorization support means for archiving without time limit, this latter being for example installed with the remote server 5. For example, data transmitted towards said remote secured memorization support means are encrypted by the energy management device 1 which thus comprises encryption means. Furthermore, owing to its built-in rechargeable battery, in case of an impromptu outage, the energy management device 1 has a sufficient autonomy to be able to store, into its memorization support means 15, the first and second local data, not to lose them.

According to an embodiment, the energy management device 1 hosts a website to which an authenticated personal communication device 6 is able to connect:
for displaying at least messages received from the remote server 5 and/or
for enabling the user of said personal communication device 6 to control the energy management device 1.

More particularly, the personal communication device 6 may be a smartphone, a personal computer, a connected television, a tablet computer, etc. which may connect to website of the energy management device 1 by help of suitable software applications installed into it. Each of these interfaces allows to read data, to process them, to format in order to return personalized services to consumers, with added value. Thus, measures of amount of produced energy, of the consumed current per each output of the distribution board 33, the state and level of load of the energy storage unit 34, allow consumers to manage the optimization of energetic flux in function of tariff signals coming from the energy meter, but also allow consumers to take advantage of an overview of energetic needs of their residence or business for the past and for the future, in order to optimize the local production of energy, the auto-consumption, the supply of electric energy to the power grid 31 and the extraction of electric energy from the power grid 31, in function of cost and availability of electric energy. Furthermore, this data made available to consumers on their interfaces allow to sensitize consumers to the energetic efficiency issue.

The downlink telecommunication facility 14 of the energy management device 1 memorization support means 15 comprises, for example, the Ethernet channel. Owing to the downlink telecommunication facility 14, the energy management device 1 is suitable at least for receiving, from the remote server 5:
at least one data 104, with this latter being remotely generated at least by said remote server 5 in function of said second local data 102, and/or
at least one data 106 relative to the state of the power grid 31.

Said at least one data 106 relative to the state of the power grid 31 comprises at least one of:
a data relative to the current or predicted state or cost of energy distributed over the power grid 31, and
an alert or warning signal or message in case of a planned outage or brownout of the power grid and, if appropriate, its estimated or planned duration.

Thus, it appears clearly that such data 106 do not depend on the optimized energy distribution, but only on the state of the power grid 31.

In case of a planned outage of the power grid 31, the energy management device 1 may advantageously ensure the energy storage unit 34 to be charged at its maximum level before the outage, for example in order to be able to supply electric energy to the medical device 42 during all the outage duration. The energy management device 1 may also determine that the energy storage unit will not be sufficient to achieve supplying energy to the medical device 42 during all the outage duration and then may alert the consumer of the incurred risk, for example by sending a message on his/her personal communication device 6.

Obviously, said remote server 5 has its own processing means owing to which it may process the second local data 102 received from the energy management device 1. Moreover, an operator of said remote server 5 may be in charge of the treatment of said second local data 102 or may be alerted from the server 5 of an event detected by analyzing said second local data 102.

First, said at least one remotely generated data 104 may comprise a measure or prediction of consuming energy by said at least one consumption device 4, 41, 42 during a past or future determined period of time, respectively, and/or an associated cost. Such a remotely generated data 104 may thus be sent to the personal communication device 6 of the consumer or be made accessible on the website of the energy management device 1 owing to its downlink telecommunication facility 14, in order for the consumer to know his/her energy consumption, potentially per usage, without awaiting for his/her invoice, for a better control of his/her energetic budget in function of the installation in the residence of alternative energy sources, of energy storage unit capacity and of tariff incentives for purchase and resale of electric energy.

Second, said at least one remotely generated data 104 may comprise a measure or prediction of supplied energy by said at least one alternative energy source 32 during a past or future determined period of time, respectively, and/or an associated gain.

Third, said at least one remotely generated data 104 may comprise:
a request from the provider for supplying electric energy to the power grid 31 in a determined amount and/or during a determined period of time,
a request from the provider for limiting the energy consumption from the power grid 31 under a determined threshold and/or during a determined period of time.

Fourth, said at least one remotely generated data 104 may comprise an alert or warning signal or message in case of detection of:
an electric fault,
a polluted air or environment, or
an exceeding with respect to said determined threshold of energy consumption from the power grid 31.

For example, said electric fault is detected on the basis of the measure of current and/or voltage at the terminals of at least one of said apparatuses 31, 32, 33, 34 and/or of said at least one consumption device 4, 41, 42; the energy management device 1 having detected an electric fault may thus trigger a circuit breaker of the distribution board 33. Furthermore, the energy management device 1 may determine, based on a historical of detected electric faults, that the distribution board 33 is dilapidated and dangerous and thus suggest its replacement.

For another example, the residence may be equipped with a carbon monoxide detector, potentially installed with the Domestic Water Heater (DWH) 41, and the energy management device is suitable for alerting by an audio signal the persons situated in the residence, for transmitting an alert message to the personal communication device 6 of the consumer and/or to firefighters, for automatically opening some controlled windows of the residence in order to aerate the residence and exhaust carbon monoxide.

For another example, a fault relative to no consumption on the distribution board 33 or to no consumption over the power grid 31 or an energy storage default may advantageously be detected. According to such examples, it appears clearly that the energy management device 1 allows to ensure security of goods and persons in the residence, particularly by preventing any risk and/or acting consequently to its occurrence.

Fifth, said at least one remotely generated data 104 may comprise an update of optimization algorithm implemented by processing means 11 of the energy management device 1 in order to optimize the energy distribution. According to a variant, the energy management device is equipped with a USB port for processing the software update or maintenance.

Sixth, said at least one remotely generated data 104 may comprise a message corresponding to a piece of advice for enhancing:
the optimization of energy distribution in function of at least one detected aberration, and/or
the efficiency of the alternative energy source 32.

Seventh, said at least one remotely generated data 104 may comprise a diagnosis of the energy management device 1. Such a diagnosis may indicate the energy consumption saved with respect to the energy consumption without optimized energy distribution. Such a diagnosis may also be a self-diagnosis made by the energy management device itself. Thus, the processing means 11 of energy management device 1 are further able to implement monitoring and self-diagnostic functions, in order to maintain performances over time.

Advantageously, the provider can thus act on, or suggest improvement of, the optimized energy distribution. Such improvement may require a manual action of the consumer or the intervention of a technical operator on site, such an intervention being thus potentially automatically planned and proposed to the consumer. Furthermore, an order of priorities may be advantageously defined between data 104, 106 received from the remote sever 5 in function of the incurred risks and/or of technical problems to be solved.

Otherwise, the processing means 11 of the energy management device 1 automatically process remotely generated data 104 or data 106 relative to the state of the power grid and, if appropriate, control means 12 of the energy management device 1 consequently adjust the optimized energy distribution.

In this case, the energy management device 1 is thus advantageously able to take into account for remotely generated data 104 and/or data 106 relative to the state of the power grid, in order to automatically take measures for enhancing the optimized energy distribution, if appropriate. For example, in case of the detection, by the remote server 5 and/or by the energy management device 1, of an aberration relative to a too high energy consumption of the Domestic Water Heater 41, that is an energy consumption relevant of the fact that a hot water valve is left open since a long time, while, in the same time, presence sensors installed in the residence indicate that there is nobody in the residence, the energy management device 1 may advantageously close an electrovalve located upstream the left open valve, in order to avoid waste.

Preferably, a message is automatically sent from the energy management device 1 to the personal communication device 6 of the consumer in order to prevent him/her of each decision and/or action automatically taken and/or done by the energy management device 1, respectively. The energy management device 1 may indicate in said message that it is awaiting for the order of the consumer before acting.

The energy management device 1 comprises memorization support means for storing at least a list of second local data type that the energy management device 1 is authorized to send to the remote server 5. Advantageously, the consumer may forbid transmission to the remote server 5 of some determined local data, for example in order to protect its privacy.

The energy management device 1 further comprises clock means at least for timestamping of each event and each measure.

Thus, the energy management device 1 together with the structural context in which it may be used forms a modular, interoperable and intercommunicable technical equipment and offers a set of modular services. The energy management device 1 thus allows consumers to access new services, with some being required by new thermic regulations and with some being personalized.

According to one embodiment, an automatic authentication process is implemented between interfaces of the consumer and other components of said modular, interoperable and intercommunicable technical equipment, including smart power socket or power bar, smart lighting, and captors. Said automatic authentication process is further implemented between each component of said modular, interoperable and intercommunicable technical equipment, including the energy management device 1, the power meter, the alternative energy source 32, the distribution board 33, each consumption device 4, 41, 42 and the energy storage unit 34.

Referring to FIG. 3, the invention further relates to an energy management method S. Said method is implemented by an energy management device 1 as described above.

Said method S comprises at least:
first processing and controlling steps S1, S2, implemented by processing and control means 11, 12 of the energy management device, for optimizing, in accordance with said at least one first local data 100, the above described electric energy distribution,
an uplink telecommunication step S3, implemented by said uplink telecommunication facility 13 of the energy management device, for sending, to the remote server 5, said at least one second local data 102 relative to the optimized energy distribution.

The energy management method S may further comprise a downlink telecommunication step S4, implemented by the downlink telecommunication facility 14 of the energy management device, for receiving from said remote server 5 said at least one data 104 remotely generated at least by said remote server 5 in function of said second local data 102.

After said downlink telecommunication step S4, the energy management method S may further comprise:
a second processing step S5, implemented by processing means 11 of the energy management device, for automatically processing data 104 received from the remote server, and
a second controlling step S6, implemented by control means 12 of the energy management device, for consequently adjusting the optimized energy distribution.

The method S may include a loop S7 according to which steps S4 to S6 are repeated until no more data 104 received from said remote server 5 has to be taken into account.

The method may then be repeated from step S1 or from step S4 at each reception of at least one data 104 from said remote server 5.

In case of no data 104 is received from said remote server 5, the method S consists in repeating steps S1 to S4 until reception of at least one data 104 from said remote server 5.

Any of the steps or modules described above may be provided in software and stored as computer-executable instructions on one or more computer-readable media. Numerals used in the appended claims are provided for clarity only and should not be interpreted to limit the order of any steps or elements recited in the claims.

1. An energy management device suitable to be connected by electrical distribution paths to a set of apparatuses comprising at least:
a power grid,
at least one alternative energy source,
at least one distribution board suitable for transmitting electric energy to at least one consumption device, and
at least one energy storage unit suitable for storing electric energy supplied at least by said alternative energy source and for supplying at least a part of stored electric energy to said power grid and/or to said distribution board, the energy management device comprising :
processing and control means for optimizing, in accordance with at least one first local data, the electric energy distribution:
to the power grid from the alternative energy source or from the energy storage unit,
to the distribution board from the power grid, from the alternative energy source or from the energy storage unit, and
to the energy storage unit from the power grid and/or from the alternative energy source,
an uplink telecommunication facility suitable at least for sending, to a remote server held by a provider of energy distributed over the power grid, at least one second local data relative to the optimized energy distribution.

2. The energy management device according to claim 1, further comprising a downlink telecommunication facility suitable for receiving, from said remote server, at least one data remotely generated at least by said remote server in function of said second local data.

3. The energy management device according to claim 1, wherein, said device being suitable to be connected to a set of captors, a part of which is arranged together with the apparatuses and/or with said at least one consumption device, said at least one first and/or second local data comprises at least one basic or pretreated data relative to:
determined operating conditions of said at least one consumption device and/or said energy management device,
a determined order of priorities for electric energy supplied at least between consumption devices,
a measure of current and/or voltage at the terminals of at least one of said apparatuses and/or of said at least one consumption device,
a measure of an amount of electric energy produced by said at least one alternative energy source,
a measure of the current consumed by said at least one consumption device,
a measure of the charge level of said at least one energy storage unit,
a measure of air and environment quality, and/or
a measure of meteorological conditions,
with said at least one pretreated data being generated by processing means of the energy management device in function of the hereabove mentioned measures.

4. The energy management device according to claim 2, wherein said at least one remotely generated data comprises at least one of:
a measure or prediction of consuming energy by said at least one consumption device during a past or future determined period of time, respectively, and/or an associated cost,
a measure or prediction of supplied energy by said at least one alternative energy source during a past or future determined period of time, respectively, and/or an associated gain,
a request from the provider for supplying electric energy to the power grid in a determined amount and/or during a determined period of time,
a request from the provider for limiting the energy consumption from the power grid under a determined threshold and/or during a determined period of time,
an alert or warning signal or message in case of detection of:
an electric fault,
a polluted air or environment, or
an exceeding with respect to a determined threshold of energy consumption from the power grid,
an update of optimization algorithm implemented by processing means of the energy management device,
a message corresponding to a piece of advice for enhancing:
the optimization of energy distribution in function of at least one detected aberration, and/or
the efficiency of the alternative energy source, and
a diagnosis of the energy management device.

5. The energy management device according to claim 2, wherein said downlink telecommunication facility is further suitable for receiving from said remote server at least one of the following data relative to power grid state:
a data relative to the current or predicted state or cost of electric energy distributed over the power grid, and
an alert or warning signal or message in case of a planned outage or brownout of the power grid and, if appropriate, its estimated or planned duration.

6. The energy management device according to claim 2, wherein processing means of the energy management device automatically process remotely generated data or data relative to power grid state and wherein control means of the energy management device consequently adjust the optimized energy distribution.

7. The energy management device according to claim 1, comprising memorization support means for storing at least a list of second local data type that the energy management device is authorized to send to the remote server.

8. The energy management device according to claim 1, hosting a website to which an authenticated personal communication device is able to connect:
for displaying at least messages received from the remote server and/or
for enabling the user of said personal communication device to control the energy management device.

9. An energy management method implemented by an energy management device suitable to be connected by electrical distribution paths to a set of apparatuses comprising at least:
a power grid ,
at least one alternative energy source,
at least one distribution board suitable for transmitting electric energy to at least one consumption device, and
at least one energy storage unit suitable for storing electric energy supplied at least by said alternative energy source and for supplying at least a part of stored electric energy to said power grid and/or to said distribution board, the energy management method comprising:
first processing and controlling steps, implemented by processing and control means of the energy management device, for optimizing, in accordance with at least one first local data, the electric energy distribution:
to the power grid from the alternative energy source or from the energy storage unit,
to the distribution board from the power grid, from the alternative energy source or from the energy storage unit, and
to the energy storage unit from the power grid and/or from the alternative energy source,
an uplink telecommunication step, implemented by an uplink telecommunication facility of the energy management device, for sending, to a remote server held by a provider of energy distributed over the power grid, at least one second local data relative to the optimized energy distribution.

10. The energy management method according to claim 9, wherein the method further comprises a downlink telecommunication step, implemented by a downlink telecommunication facility of the energy management device, for receiving from said remote server at least one data remotely generated at least by said remote server in function of said second local data.

11. The energy management method according to claim 10, wherein the method further comprises:
a second processing step, implemented by processing means of the energy management device, for automatically processing data received from the remote server, and
a second controlling step, implemented by control means of the energy management device, for consequently adjusting the optimized energy distribution.

12. A non-transitory computer program storage medium comprising code executable by a computer or by processing means of an energy management device according to claim 1, this computer program having a sequence of instructions for implementing an energy management method implemented by an energy management device suitable to be connected by electrical distribution paths to a set of apparatuses comprising at least:
a power grid,
at least one alternative energy source,
at least one distribution board suitable for transmitting electric energy to at least one consumption device, and
at least one energy storage unit suitable for storing electric energy supplied at least by said alternative energy source and for supplying at least a part of stored electric energy to said power grid and/or to said distribution board,
the energy management method comprising:
first processing and controlling steps, implemented by processing and control means of the energy management device, for optimizing, in accordance with at least one first local data, the electric energy distribution:
to the power grid from the alternative energy source or from the energy storage unit,
to the distribution board from the power grid, from the alternative energy source or from the energy storage unit, and
to the energy storage unit from the power grid and/or from the alternative energy source,
an uplink telecommunication step, implemented by an uplink telecommunication facility of the energy management device, for sending, to a remote server held by a provider of energy distributed over the power grid, at least one second local data relative to the optimized energy distribution.
